(19) United States
(12) Patent Application Publication
(10) Pub. No.: US 2026/0162347 A1
(43) Pub. Date: Jun. 11, 2026

(54) METHOD AND APPARATUS FOR GENERATING VIDEO FROM IMAGE, AND ELECTRONIC DEVICE

(71) Applicant: BEIJING BYTEDANCE NETWORK TECHNOLOGY CO., LTD., Beijing (CN)

(72) Inventors: Xiaoqian WANG, Beijing (CN); Yulong LIU, Beijing (CN)

(21) Appl. No.: 18/707,481

(22) PCT Filed: Nov. 8, 2022
(86) PCT No.: PCT/CN2022/130624

§ 371 Date: May 3, 2024

(30) Foreign Application Priority Data
Nov. 9, 2021 (CN) 202111318900.7

(51) Int. Cl. G06T 13/80; G06T 3/40; G06T 7/20; G06T 11/00; G06V 10/26; G06V 10/82

(52) U.S. Cl. CPC G06T 13/80; G06T 3/40; G06T 7/20; G06T 11/00; G06V 10/26; G06V 10/82; G06T 2207/20081; G06T 2207/20084; G06T 2210/16; G06T 2210/24

(57) ABSTRACT

The present disclosure relates to a method and apparatus for generating a video from an image, and an electronic device. The method for generating a video from an image comprises: obtaining a first image; inputting the first image into a target image processing model; obtaining a first flow parameter outputted by the target image processing model for the first image; performing flow processing on the first image on the basis of the first flow parameter so as to generate a plurality of second image frames; and combining the plurality of second image frames to obtain a video, the first flow parameter comprising at least one area and a flow direction of each area.

### CROSS-REFERENCE TO RELATED APPLICATIONS

This application claims priority to and is based on Chinese Application Number 202111318900.7 filed on Nov. 9, 2021, the aforementioned application is hereby incorporated by reference in its entirety.

### FIELD OF THE INVENTION

The invention relates to the technical field of image processing, in particular to method, apparatus and electronic device for generating a video from an image.

### BACKGROUND

At present, there are objects such as hair, clothing, etc. in some images, and these objects are in flow states in the actual scene, when it is necessary to present the flow effects of these objects, a method of generating videos with flow effects is urgently needed.

### DISCLOSURE OF THE INVENTION

In order to solve or at least partially solve the above technical problems, the present disclosure provides a method, apparatus and electronic device for generating a video from an image. A video with streaming effect can be generated from still images.

In order to achieve the above objects, the technical schemes according to the embodiments of the present disclosure are as follows:

In a first aspect, there is provided a method for generating a video from an image includes:
acquiring a first image;
inputting the first image into a target image processing model to acquire a first flow parameter output by the target image processing model for the first image, wherein the first flow parameter includes at least one region and a flow direction of each region;
performing processing on the first image based on the first flow parameter to generate a plurality of frames of second images; and combining the plurality of frames of second images to obtain a video.

In a second aspect, there is provided an apparatus for generating a video from an image, including:
an acquisition module configured to acquire a first image; input the first image into a target image processing model to acquire a first flow parameter output by the target image processing model for the first image, wherein the first flow parameter includes at least one region and a flow direction of each region;
a generation module configured to perform flow processing on the first image based on the first flow parameter to generate a plurality of frames of second images; and combine the plurality of frames of second images to obtain a video.

In a third aspect, there is provided an electronic device, which includes a processor and a memory, wherein a computer program is stored on the memory, and the computer program, when executed by the processor, causes implementation of the method for generating a video from an image as in the first aspect or any embodiment of the present disclosure.

In a fourth aspect, there is provided a computer-readable storage medium, including: a computer program stored on the computer-readable storage medium, which, when executed by a processor, causes implementation of the method for generating a video from an image as in the first aspect or any embodiment of the present disclosure. In a fifth aspect, there is provided a computer program product, wherein, the computer program product, when executed on a computer, causes the computer to implement the method for generating a video from an image as in the first aspect or any embodiment of the present disclosure.

In a sixth aspect, there is provided a computer program including program codes which, when executed on a computer, causes the computer to implement the method for generating a video from an image as in the first aspect or any embodiment of the present disclosure.

### DESCRIPTION OF THE DRAWINGS

The accompanying drawings, which are incorporated in and constitute a part of the present specification, illustrate embodiments of the present disclosure, and explain the principles of the present disclosure together with the specification.

In order to more clearly illustrate the embodiments of the present disclosure or technical solutions in the prior art, the drawings needed to be used in the description of the embodiments or the prior art will be briefly introduced below, obviously, for those of ordinary skill in the art, other drawings can be obtained based on these drawings without paying any creative labor.

FIG. 1 is a flow chart 1 of a method for generating a video from an image according to an embodiment of the present disclosure;

FIG. 2 is a flow chart 2 of a method for generating a video from an image according to an embodiment of the present disclosure;

FIG. 3 is a structural block diagram of an apparatus for generating a video from an image according to an embodiment of the present disclosure;

FIG. 4 is a schematic structural diagram of an electronic device according to an embodiment of the present disclosure.

### DETAILED DESCRIPTION OF PREFERRED EMBODIMENTS

In order to be able to understand the above objects, features and advantages of the present disclosure more clearly, the solutions of the present disclosure will be further described below. It should be noted that the embodiments of the present disclosure and the features in the embodiments can be combined with each other without conflict.

In the following description, numerous specific details are set forth in order to provide a thorough understanding of the present disclosure, but the present disclosure may be practiced in other ways than as described herein; obviously, the embodiments in the specification are only a part of the embodiments of the present disclosure, but not all of the embodiments.

The terms such as ‘first’ and ‘second’ are only used to distinguish different objects, without being used to describe specific orders of objects. For example, the first image and the second image are used to distinguish different images, instead of describing the specific order of images.

There are objects such as hair and clothing in some images, when it is necessary to present the flow effects of these objects, it is necessary to a video with flow effects with respect to objects such as hair and clothing in a still image, and thus a method of generating a video with flow effects from a still image is urgently needed.

In some embodiments, a display special effect can be realized to make a part of regions in the image to flow, in a specific implementation process, the user needs to manually select a region in the image, set information such as a flow direction, etc., and then generate a video. In the process of generating a video with flow effects from an image, it is necessary to manually select regions and set the flow directions for these regions, therefore, the implementation of the process of generating a video with flow effects from an image is highly complex.

An embodiment of the present disclosure provides a method for generating a video from an image, through generating flow parameters (region and flow directions) corresponding to the first image based on a target image processing model, the method can further generate a video with flow effects based on the generated flow parameters and the first image. Compared with manually selecting a region and setting the flow direction to generate a video with flow effects, the complexity of implementation of generating a video with flow effects through an image can be reduced.

The above method for generating a video from an image can be applied to an apparatus or electronic device for generating a video from an image, and the apparatus for generating a video from an image can be a functional module or functional entity in an electronic device that can implement the method for generating a video from an image.

The above-mentioned electronic device can be a server, a tablet computer, a mobile phone, a notebook computer, a palm computer, a vehicle terminal, a wearable device, an ultra-mobile personal computer (UMPC), a netbook, a personal digital assistant (PDA), a personal computer (PC), etc., which are not specifically limited by embodiments of the present disclosure.

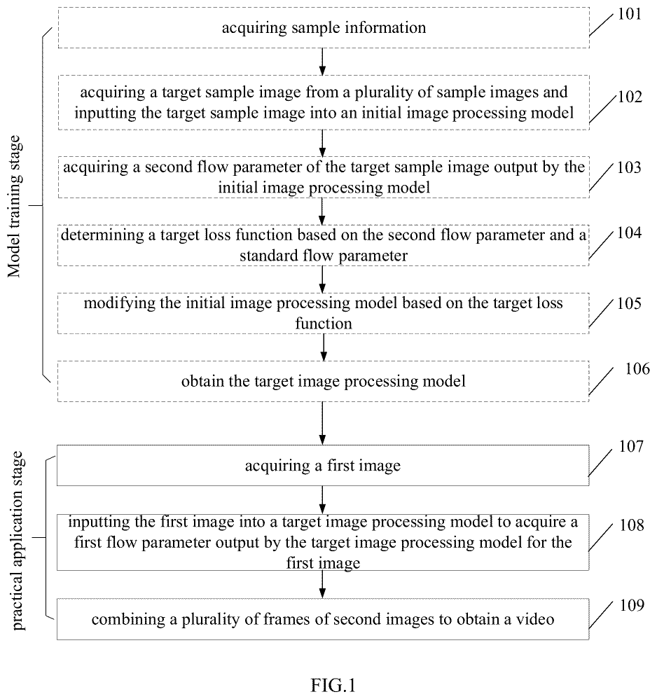

As shown in FIG. 1, which is a flow diagram of a method for generating a video from an image according to an embodiment of the present disclosure, the method may include two stages: a model training stage and a practical application stage.

The model training stage may include the following steps 101 to 106.
101. acquiring sample information.

Wherein, the sample information includes a plurality of sample images and a standard flow parameter for each sample image; the standard flow parameter may include at least one region, a flow direction of each region, and a flow velocity of each region.

Wherein, the above-mentioned region may refer to a flowable region. In view of the fact that some subjects in the image, such as water flow, hair, clothing, etc., can flow in an actual scene, such regions such as water flow, hair, clothing, etc. in the image can be determined as flowable regions in an embodiment of the present disclosure, which are also be referred to as flow regions in an embodiment of the present disclosure.

In some embodiments, acquiring sample information includes acquiring an original image; performing geometric transformation and/or color transformation on the original image to obtain at least one transformed image; the original image and at least one transformed image are taken as sample images in the sample information.

In the actual model training process, in order to represent the accuracy of the model, a large number of image data are needed as training samples, so it is necessary to make full use of the existing images to perform data enhancement so as to obtain more training samples. The meaning of data enhancement in this disclosure is to make limited data to produce values equivalent to more data without substantially increasing data, when the data enhancement is utilized to enhance a sample image, it can perform geometric transformation and/or color transformation on the sample image to obtain a plurality of enhanced images.

Among them, the geometric transformation operation does not change the contents of the image itself. The geometric transformation can include at least one of flipping, rotating, cropping, deforming, and scaling.

In an embodiment of the present disclosure, performing geometric transformation, such as random scaling, random cropping, etc., on an image, and taking the transformed image as a sample image in the sample information, can improve accuracy of a subsequently trained target image processing model for recognizing flow regions with different sizes and different positions.

In an embodiment of the present disclosure, based on a situation that the flow direction of a hair region, a clothing region and the like is an unidirectional direction, it is proposed to randomly rotate the image, and take the randomly rotated image as the sample image in the sample information, which can improve the robustness of the subsequently-trained target image processing model with respect to different flow directions.

The above-mentioned random flipping and random rotation will not change the size of the image, while the random cropping will change the size of the image due to cropping out a part of contents of the original image, and the image obtained after cropping will be smaller than the original image.

Among them, color transformation can include at least one of noise addition and color disturbance. The data enhancement by color transformation generally changes the contents of the image.

In some embodiments, data enhancement based on noise addition is to overlap some noises, most commonly Gaussian noises, randomly on the basis of the original image. In some implementations, some pixels can be discarded in a rectangular region with a selectable area size and a random position, so that the image can produce some color noises.

Color disturbance is to change the color of the original image by increasing or decreasing some color components or changing the order of color channels in a certain color space, so as to obtain a variety of images after color change.

In an embodiment of the present disclosure, in view of a situation that light-colored hair and light-colored clothing may not be correctly divided into flow regions, it is proposed to perform the color disturbance on the original image to increase various images after color disturbance as sample images, and after training based on such image samples, the misclassification of light-colored regions by the image processing model can be reduced.

In an embodiment of the present disclosure, when acquiring the sample information, a plurality of sample images may be images based on self-owned image resources and images obtained by data enhancement based on existing image resources. When acquiring the standard processing parameter for each sample image, a flow region mask can be labelled based on each sample image by manual labelling to obtain the flow region of each sample image, and the vectors of flow direction and flow velocity in the flow region of each sample image can be labelled by manual labelling to obtain the flow direction and flow velocity in the flow region of each sample image.

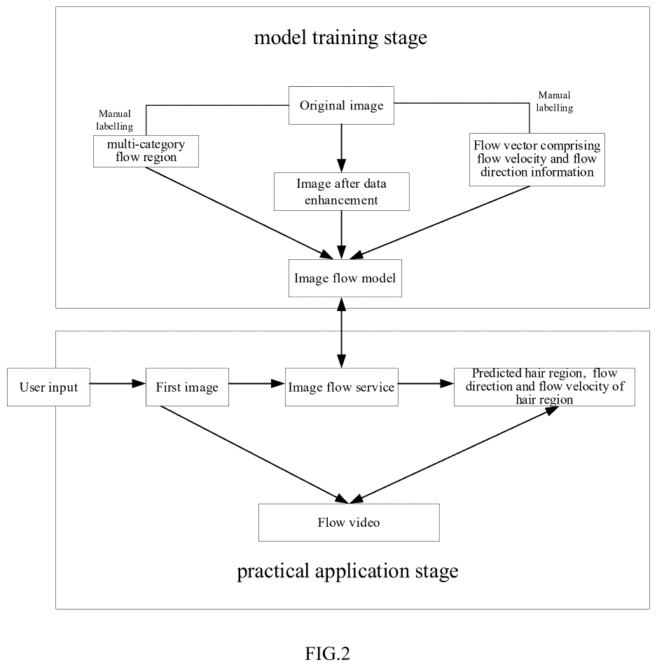

Illustratively, as shown in FIG. 2, which is a schematic diagram of the training process and application process of an image processing model, it can be seen from FIG. 2 that it can, from the original image, generate the flow region mask by manual labelling, and generate the flow direction and flow velocity of each flow region, and then take such information as sample information for training the image processing model.

The above sample information can be an image flow data set for full scene established based on self-owned image resources.

In an embodiment of the present disclosure, different types of flow parameters are set for different scenes. That is to say, there are some regions to be processed and the flow parameters of these regions for each scene. That is, in an embodiment of the present disclosure, a first flow parameter may include flow parameter corresponding to at least one scene, and the flow parameter corresponding to each scene includes at least one homogeneous region (i.e., the same type of flow regions, such as two hair regions) and the flow parameter of each region.

For a main coverage scene, the labeling rules for flow region, flow direction and flow velocity established in the present disclosure are as follows:
(1) For a scene including a figure image, the hair and beard regions of the figure are flow regions, the growth direction of the hair and beard is the flow direction, and the flow velocity can be uniform based on a certain fixed velocity;
(2) For a scene including an animal image, the animal's hair region is the flow region, the hair texture direction of the hair is the flow direction, and the flow velocity can be uniform based on a certain fixed velocity.
(3) For a scene including a clothing image: the clothing region is a flow region, the directions of wrinkles and curves of the clothing are the flow directions, the direction from top to bottom of a trunk in the clothing region is the flow direction, the direction from shoulder to hand is the flow direction, or the direction from thigh to toe is the flow direction, and the flow velocity can be uniform based on a certain fixed velocity
(4) For a scene including a sky image: for example, the cloud region is a flow region, the natural flow direction of the cloud is the flow direction, or the flow direction is the direction from left to right, and the flow velocity can be uniform based on a certain fixed velocity.
(5) For a scene including water flow: the water flow region is the flow region, and the natural flow direction of the water flow is the flow direction, or the direction of flow from high to low is the flow direction, and the flow velocity can be uniform based on a certain fixed velocity.

For an image, by means of manual labeling information, a mask including multi-category flow regions and a flow vector including flow direction and flow velocity information may be finally generated.

102. acquiring a target sample image from a plurality of sample images and inputting the target sample image into an initial image processing model.

Among them, the target sample image can be any one of a plurality of sample images.

103. acquiring a second flow parameter of the target sample image output by the initial image processing model.

Among them, the second flow parameter may include at least one flow region of the target sample image, and the flow direction and flow velocity of each flow region.

104. determining a target loss function according to the second flow parameter and a standard flow parameter.

105. modifying the initial image processing model based on the target loss function.

The target loss function includes at least one of the following: cross entropy loss function, total variation loss function, dice loss function, focal loss function, L1 regular loss function.

In an embodiment of this disclosure, in order to ensure accuracy of the algorithm, the cross-entropy loss function, the total variation loss function and the L1 canonical loss function can be weight combined to supervise the prediction of the flow region, flow direction and flow velocity in the image processing model.

The above-mentioned cross entropy loss function mainly acts on the accuracy of identifying the flow region, so in some embodiments, setting the weight for the cross entropy loss function higher can improve the prediction accuracy of the flow region, while the LI canonical loss function mainly acts on the accuracy of the flow vector (flow velocity and flow direction), so setting the weight for the L1 canonical loss function higher can improve the prediction accuracy of the flow vector.

Further, because the total variation loss function acts on the smoothing of the flow vector in the flow region, in order to solve a problem that the flow effect is disordered due to the excessive difference of the flow vectors in a local region, an embodiment of the present disclosure introduces the total variation loss function to predict the flow vector, which can further improve the smoothness of the flow effect and make the picture effect smoother.

106. Loop the above steps 102 to 105 at least once to obtain the target image processing model.

According to an embodiment of the present disclosure, the number of loops in the training process of the target image processing model as mentioned above can be appropriately determined in any way. For example, it can be preset to a specific value, or it can be dynamically set according to the training result. As an example, the processing results of the model can be analyzed during the training process, and when the processing results meet certain conditions, such as processing accuracy meets requirements, prediction results meet requirements, and so on, the training process can be terminated to obtain the target image processing model. As another example, the training process can be terminated after a certain number of loops, and the target image processing model can be obtained. The number of training processes can also be set in an appropriate way in the art, which will not be described in detail here.

In an embodiment of the present disclosure, the target image processing model may be a neural network model. In some embodiments, in order to ensure the accuracy of accurately predicting the flow parameters, the target image processing model adopts a semantic segmentation model based on a High-Resolution Network (HR Net), or the target image processing model is a semantic segmentation model based on a variant of the high-resolution network model. This kind of model can have higher calculation accuracy, in which the amount of calculation is large and there are many operation parameters, which is more suitable for being configured in the service side, that is, being configured for usage in the server.

In some embodiments, the above target image processing model may include multiple down-sampling operations and/or multiple convolution operations.

In some embodiments, when configuring multiple down-sampling operations and operation-related parameters in the target image processing model, different operation-related parameters can be set for adjacent down-sampling operations.

In some embodiments, when configuring operation-related parameters for multiple convolution operations in the target image processing model, different operation-related parameters can be set for adjacent convolution operations.

The operation-related parameter may include at least one of kernel size, dilation coefficient and stride.

That is, at least one of the down-sampling kernel size, down-sampling dilation coefficient and down-sampling stride can be set differently for adjacent down-sampling operations; at least one of the convolution kernel size, convolution dilation coefficient, and convolution stride can also be set differently for adjacent convolution operations.

In an embodiment of the present disclosure, different operation-related parameters are set for the adjacent down-sampling operations or convolution operations in the model network, which can avoid a gridding effect caused by processing the image data at a fixed position every time when the down-sampling operation or convolution operation is performed, and improve the gridding effect problem occurring in the predicted flow region mask.

The practical application stage may include the following steps 107 to 110.

107. acquiring a first image.

As shown in FIG. 2, a user can trigger an electronic device through a user input to generate a video with the flow effect based on the first image, and an image flow service (which can be a special effect prop associated with the image processing model) can be triggered for use to generate a video with the flow effect during the user input process. When the image streaming service is trigger for use, the trained image processing model (i.e., the target image processing model) will be invoked to process the first image and predict the corresponding flow parameter.

108. inputting the first image into a target image processing model to acquire a first flow parameter output by the target image processing model for the first image.

Among them, the first flow parameter may include at least one region (also referred to as flow region in an embodiment of the present disclosure), the flow direction of each region, and the flow velocity of each region.

In some embodiments, inputting the first image into the target image processing model includes down-sampling the first image to obtain a down-sampled first image, and inputting the down-sampled first image into the target image processing model.

Down-sampling of an image can be understood as: down-sampling a resolution image with an image size of M*N by s times, that is, acquiring a resolution image with an image size of (M/s) *(N/s), where s is the common divisor of M and N. In the process of down-sampling, every image of s*s pixels of the original image are turned into a pixel, and the value of this pixel can be an average value of all pixels in the window.

For example, by down-sampling the first image, the first image can be converted into a small-size image, thus reducing the calculation amount and time consumption for the target image processing model.

In some embodiments, the first flow parameter may not include the flow velocity, in which case the target image processing model may not predict the flow velocity, and the flow velocity may be a default fixed flow velocity.

109. performing processing on the first image based on the first flow parameter to generate a plurality of frames of second images.

110. combining the plurality of frames of second images to obtain a video.

As shown in FIG. 2, based on the first image and the target image processing model, at least one flow region in the first image, as well as the flow direction and flow velocity of each flow region can be predicted, furthermore, the flow processing can be performed on the first image based on these predicted flow parameters, and multiple frames of second images can be obtained in the temporal order of video frames, so that a videos, that is, a video with flow effects, can be obtained.

When the flow processing can be performed on the first image based on the first flow parameter, multiple frames of second images can be generated in a temporal order, and the multiple frames of second images can be combined in the temporal order, so that a video with flow effects can be obtained.

With respect to the ghost problem at boundaries of multiple flow regions, in order to prevent a non-flow region from flowing, an embodiment of the present disclosure can make use of the object prominence to reduce the flow vectors at the boundaries of multiple flow regions, so as to avoid the pixel crossing between different regions, and restrict the flow velocities in the flow regions by regions and levels. Specifically, when the flow processing is performed on the first image based on the flow parameters, the flow velocity of the edge region can be restricted to be less than that of the central region in each flow region.

Further, it is also possible to set different flow velocity ranges for the edge region and the central region in the flow region, and restrict the flow velocity of the edge region in each flow region and the flow velocity of the central region in each flow region based on the corresponding flow velocity ranges respectively.

The method for generating a video from an image according to an embodiment of the present disclosure can acquire a first image; input the first image into a target image processing model to acquire a first flow parameter output by the target image processing model for the first image, wherein the first flow parameter includes at least one region and a flow direction of each region; perform processing on the first image based on the first flow parameter to generate a plurality of frames of second images; and combine the plurality of frames of second images to obtain a video. Through the scheme, since the flow parameters (region and flow directions) corresponding to the first image can be generated based on the target image processing model, a video with flow effects can be further generated based on the generated flow parameters and the first image, so as to implement a video with flow effects through still images.

It should be pointed out that the model training process/model training stage as described above, especially steps 101-106, is optional for the scheme of the present disclosure. In particular, such a model training process/model training stage can be included in the method for generating a video from an image of the present disclosure, or located outside the method for generating a video from an image of the present disclosure, and acquired and applied by the method for generating a video from an image of the present disclosure. Therefore, it is shown by dotted lines in the drawings. It should be pointed out that even if the model training process/model training stage is not inclusive, the method for generating a video from an image of the present disclosure is still complete, and the aforementioned advantageous technical effects can be achieved.

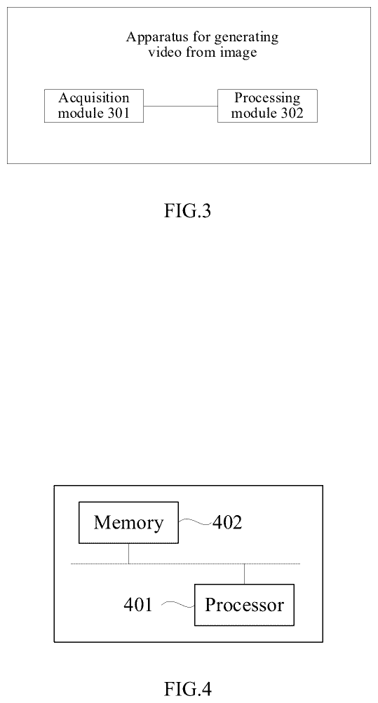

As shown in FIG. 3, an embodiment of the present disclosure provides a structural block diagram of an apparatus for generating a video from an image, which includes:
an acquisition module 301 configured to acquire a first image; input the first image into a target image processing model to acquire a first flow parameter output by the target image processing model for the first image, wherein the first flow parameter includes at least one region and a flow direction of each region;
a generation module 302 configured to perform flow processing on the first image based on the first flow parameter to generate a plurality of frames of second images; and combine the plurality of frames of second images to obtain a video.

As an alternative to the embodiment of the present disclosure, the flow parameter can also include: a flow velocity of each region.

As an alternative to the embodiment of the present disclosure, the target image processing model is a neural network model trained based on sample information, which may include a plurality of sample images and a standard flow parameter of each sample image;

The acquisition module 301 is further configured to: before inputting the first image into a target image processing model to acquire a first flow parameter output by the target image processing model for the first image, acquire sample information;
loop the following steps at least once to obtain the target image processing model:
acquiring a target sample image from a plurality of sample images and input the target sample image into an initial image processing model;
acquiring a second flow parameter of the target sample image output by the initial image processing model;
determining a target loss function according to the second flow parameter and a standard flow parameter;
modifying the initial image processing model based on the target loss function.

As an alternative to the embodiment of the present disclosure, the target loss function may include at least one of the following: cross entropy loss function, total variation loss function, dice loss function, focal loss function, L1 regular loss function.

As an alternative to the embodiment of the present disclosure, the acquisition module is specifically configured to:
acquire an original image;
perform geometric transformation and/or color transformation on the original image to obtain at least one transformed image; and
taking the original image and at least one transformed image as sample images in the sample information.

As an alternative to the embodiment of the present disclosure, the geometric transformation may include at least one of flipping, rotating, cropping, deforming and scaling;

As an alternative to the embodiment of the present disclosure, the color transformation may include at least one of noise addition and color disturbance.

As an alternative to the embodiment of the present disclosure, the acquisition module 301 is specifically configured to:
down-sample the first image to obtain a down-sampled first image;
input the down-sampled first image to the target image processing model.

As an alternative to the embodiment of the present disclosure, the flow velocity of the edge region in each region is less than the flow velocity of the central region.

As an alternative to the embodiment of the present disclosure, the target image processing model may include multiple down-sampling operations and/or multiple convolution operations,
for adjacent down-sampling operations and/or adjacent convolution operations, operation-related parameters are different;
wherein the operation-related parameter may include at least one of the following:
kernel size, dilation coefficient and stride.

As an alternative to the embodiment of the present disclosure, the target image processing model is a semantic segmentation model based on a high-resolution network model.

It should be noted that each of the above modules only belongs to a logical module classified according to the specific function it implements, instead of limiting its specific implementation manner, for example, it can be implemented in software, hardware, or a combination of software and hardware. In an actual implementation, each of the above modules may be implemented as separate physical entity, or may be implemented by a single entity (for example, a processor (CPU or DSP, etc.), an integrated circuit, etc.). In addition, the above-described modules are shown in the drawings in dash lines to indicate that such modules actually cannot exist, the operations/functionalities that they implement can be implemented by the apparatus or a processing circuit itself.

In addition, although not shown, the apparatus may also include a memory that may store various information generated by the apparatus, various modules included in the apparatus during operation, programs and data for operations, data to be sent by the communication unit, etc. The memory may be a volatile memory and/or a non-volatile memory. For example, a memory may include, but is not limited to, random access memory (RAM), dynamic random-access memory (DRAM), static random-access memory (SRAM), read only memory (ROM), and flash memory. Of course, the memory may also be located external to the apparatus.

An embodiment of the present disclosure provides an electronic device, as shown in FIG. 4, which includes a processor 401, a memory 402, and a computer program stored in the memory 402 and executable on the processor 401, the computer program, when executed by the processor 401, implements the method for generating a video from an image involved in the above method embodiments.

An embodiment of the present disclosure provides a computer-readable storage medium on which a computer program is stored, the computer program, when executed by a processor, causes implementation of the method for generating a video from an image involved in the above method embodiments.

Among them, the computer-readable storage medium may be read only Memory (ROM), random access memory (RAM), magnetic disk, or optical disk, and so on.

An embodiment of the present disclosure provides a computer program product, which, when executed on a computer, causes the computer to implement the method for generating a video from an image involved in the above method embodiments.

An embodiment of the present disclosure provides a computer program including program codes which, when executed on a computer, causes the computer to implement the method for generating a video from an image involved in the above method embodiments.

It should be understood by those skilled in the art that embodiments of the present disclosure can be provided as method, system, or computer program product. Therefore, the present disclosure can take the form of an entirely hardware embodiment, an entirely software embodiment, or an embodiment combining software and hardware aspects. Moreover, the present disclosure may take the form of a computer program product embodied on one or more computer usable storage media having computer usable program codes embodied therein.

In the present disclosure, the processor may be a Central Processing Unit (CPU), may also be other general processors, Digital Signal Processor (DSP), application specific integrated circuits (ASIC), Field-Programmable Gate Array (FPGA) or other programmable logic devices, discrete gate or transistor logic devices, discrete hardware components, etc. The general processor can be a microprocessor, or the processor can be any conventional processor, etc.

In the present disclosure, the memory may include non-permanent memory, random access memory (RAM) and/or non-volatile memory in computer-readable media, such as read-only memory (ROM) or flash RAM. Memory can be an example of a computer-readable medium.

In the present disclosure, a computer-readable medium can include permanent and non-permanent, removable, and non-removable storage media. The storage medium can store information by any method or technology, and the information can be computer-readable instructions, data structures, program modules or other data. Examples of storage media for computers include, but not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, CD-ROM, digital versatile disc (DVD) or other optical storage, magnetic cassette tape, magnetic disk storage, or other magnetic storage or any other non-transmission medium, that can be used for storing any information accessible to a computing device. According to the definition in the context of the description, the computer-readable media does not include transitory media, such as modulated data signals and carrier waves.

It should be noted that, relational terms such as ‘first’ and ‘second’ are only used to distinguish one entity or operation from another entity or operation, without requiring or implying such actual relationship or order between such entities or operations. The terms “comprise”, “include” or any other variation thereof are intended to encompass a non-exclusive inclusion, so that a process, method, article, or apparatus comprising a series of elements includes not only those elements, but also other elements not explicitly listed, or elements inherent to such a process, method, article, or apparatus. Without further limitation, the element as defined by the phrase “comprising a” does not preclude presence of additional identical elements in a process, method, article, or apparatus that includes said element.

What has been described above is only a specific implementation of the present disclosure so as to enable those skilled in the art to understand or implement the disclosure. Various modifications to the embodiments will be readily apparent to those skilled in the art, and the generic principles defined herein may be implemented in other embodiments without departing from the spirit or scope of the disclosure. Therefore, the present disclosure is not to be limited to the embodiments set forth herein, but is to be accorded the widest scope consistent with the principles and novel features disclosed herein.

1. A method for generating a video from an image, comprising:
acquiring a first image;
inputting the first image into a target image processing model to acquire a first flow parameter output by the target image processing model for the first image, wherein the first flow parameter includes at least one region and a flow direction of each region;
performing processing on the first image based on the first flow parameter to generate a plurality of frames of second images; and combining the plurality of frames of second images to obtain a video.

2. The method of claim 1, wherein the processing parameter further comprises the flow velocity of each region.

3. The method of claim 1, wherein,
the target image processing model is a neural network model trained based on sample information, which includes a plurality of sample images and a standard flow parameter of each sample image;
before inputting the first image into a target image processing model to acquire a first flow parameter output by the target image processing model for the first image, the method further comprises:
acquiring sample information;
looping the following steps at least once to obtain the target image processing model:
acquiring a target sample image from a plurality of sample images and input the target sample image into an initial image processing model;
acquiring a second flow parameter of the target sample image output by the initial image processing model;
determining a target loss function based on the second flow parameter and a standard flow parameter;
modifying the initial image processing model based on the target loss function.

4. The method of claim 3, wherein the target loss function comprises at least one of:
cross entropy loss function, total variation loss function, dice loss function, focal loss function, L1 regular loss function.

5. The method of claim 3, wherein the acquiring sample information comprises:
acquiring an original image;
performing geometric transformation and/or color transformation on the original image to obtain at least one transformed image;
taking the original image and the at least one transformed image as sample images in the sample information.

6. The method of claim 5, wherein, the geometric transformation includes at least one of flipping, rotating, cutting, deforming and scaling;
and/or,
the color transformation includes adding at least one of noise and color disturbance.

7. The method of claim 1, wherein inputting the first image into a target image processing model comprises:
down-sampling the first image to obtain the down-sampled first image;
inputting the down-sampled first image to the target image processing model.

8. The method of claim 2, wherein the flow velocity of the edge region in each region is less than that of the central region.

9. The method of claim 1, wherein the target image processing model comprises a plurality of down-sampling operations and/or a plurality of convolution operations,
for adjacent down-sampling operations and/or adjacent convolution operations, the operation-related parameters are different;
wherein the operation-elated parameter comprises at least one of the following:
kernel size, dilation coefficient and stride

10. The method of claim 1, wherein the target image processing model is a semantic segmentation model based on a high-resolution network model.

11. The method of claim 1, wherein the target image processing model is a neural network model.

12. The method claim 1, wherein generating multiple frames of second images comprises: generating the plurality of frames of second images in temporal order of video frames; and
combining the plurality of frames of second images to obtain a video, comprising:
combining the plurality of frames of second images in the temporal order to obtain a video.

13. (canceled)

14. An electronic device, comprising a processor and a memory, wherein a computer program is stored on the memory, and the computer program, when executed by the processor, causes the processor to implement:
acquiring a first image;
inputting the first image into a target image processing model to acquire a first flow parameter output by the target image processing model for the first image, wherein the first flow parameter includes at least one region and a flow direction of each region;
performing processing on the first image based on the first flow parameter to generate a plurality of frames of second images; and combining the plurality of frames of second images to obtain a video.

15. A non-transitory computer-readable storage medium, including: a computer program stored on the computer-readable storage medium, which, when executed by a processor, causes the processor to implement:
acquiring a first image;
inputting the first image into a target image processing model to acquire a first flow parameter output by the target image processing model for the first image, wherein the first flow parameter includes at least one region and a flow direction of each region;
performing processing on the first image based on the first flow parameter to generate a plurality of frames of second images; and combining the plurality of frames of second images to obtain a video.

16-17. (canceled)

18. The electronic device of claim 14, wherein,
the target image processing model is a neural network model trained based on sample information, which includes a plurality of sample images and a standard flow parameter of each sample image;
wherein the computer program, when executed by the processor, causes the processor to implement, before inputting the first image into a target image processing model to acquire a first flow parameter output by the target image processing model for the first image:
acquiring sample information;
looping the following steps at least once to obtain the target image processing model:
acquiring a target sample image from a plurality of sample images and input the target sample image into an initial image processing model;
acquiring a second flow parameter of the target sample image output by the initial image processing model;
determining a target loss function based on the second flow parameter and a standard flow parameter;
modifying the initial image processing model based on the target loss function.

19. The electronic device of claim 14, wherein inputting the first image into a target image processing model comprises:
down-sampling the first image to obtain the down-sampled first image;
inputting the down-sampled first image to the target image processing model.

20. The electronic device of claim 14, wherein generating multiple frames of second images comprises: generating the plurality of frames of second images in temporal order of video frames; and
combining the plurality of frames of second images to obtain a video, comprising:
combining the plurality of frames of second images in the temporal order to obtain a video.

21. The non-transitory computer-readable storage medium of claim 15, wherein,
the target image processing model is a neural network model trained based on sample information, which includes a plurality of sample images and a standard flow parameter of each sample image;
wherein the computer program, when executed by the processor, causes the processor to implement, before inputting the first image into a target image processing model to acquire a first flow parameter output by the target image processing model for the first image:
acquiring sample information;
looping the following steps at least once to obtain the target image processing model:
acquiring a target sample image from a plurality of sample images and input the target sample image into an initial image processing model;
acquiring a second flow parameter of the target sample image output by the initial image processing model;
determining a target loss function based on the second flow parameter and a standard flow parameter;
modifying the initial image processing model based on the target loss function.

22. The non-transitory computer-readable storage medium of claim 15, wherein inputting the first image into a target image processing model comprises:
down-sampling the first image to obtain the down-sampled first image;
inputting the down-sampled first image to the target image processing model. Preliminary Amendment: First Action Not Yet Received

23. The non-transitory computer-readable storage medium of claim 15, wherein generating multiple frames of second images comprises: generating the plurality of frames of second images in temporal order of video frames; and
combining the plurality of frames of second images to obtain a video, comprising:
combining the plurality of frames of second images in the temporal order to obtain a video.
